(19) United States
(12) Patent Application Publication
(10) Pub. No.: US 2025/0313777 A1
(43) Pub. Date: Oct. 9, 2025

(54) TREATMENT COMPOSITIONS COMPRISING ETHOXYQUIN

(71) Applicant: The Procter & Gamble Company, Cincinnati, OH (US)

(72) Inventors: Ryan Johnie SMITH, Cincinnati, OH (US); Mu WANG, Cincinnati, OH (US)

(21) Appl. No.: 19/064,796

(22) Filed: Feb. 27, 2025

Related U.S. Application Data
(60) Provisional application No. 63/568,150, filed on Mar. 21, 2024.

(51) Int. Cl. C11D 3/28; C11D 1/22; C11D 1/72; C11D 1/831; C11D 3/00; C11D 3/386; C11D 3/42

(52) U.S. Cl. CPC C11D 3/28; C11D 1/22; C11D 1/72; C11D 1/831; C11D 3/0084; C11D 3/386; C11D 3/42; C11D 2111/12

(57) ABSTRACT

A treatment composition includes from about 0.01 to about 3 wt % of ethoxyquin; ethoxyquin dimer; and from about 1 wt % to about 20 wt % of nonionic surfactant. A method for treating a stain on a fabric includes washing the fabric in a wash liquor comprising a treatment composition. The treatment composition includes from about 0.01 to about 3 wt % of ethoxyquin; ethoxyquin dimer; and from about 5 wt % to about 20 wt % of nonionic surfactant.

### TECHNICAL FIELD

The present disclosure relates to treatment compositions comprising ethoxyquin. The present disclosure further relates to related methods of use and preparation of such compositions.

### BACKGROUND

Many treatment processes, such as laundry wash processes, are designed to eliminate soils from surfaces, such as fabrics. Some soils can cause malodors on fabrics, which may persist or even form after the treatment process is finished. Thus, manufacturers of consumer products and industrial cleaning products are continuously seeking to provide compositions and processes that provide improved malodor control.

Antioxidants and surfactants are conventionally used in detergent compositions. Such antioxidants and surfactants may facilitate certain cleaning benefits, such malodor removal. However, it has been found that the compositions of the present disclosure, which include ethoxyquin and nonionic surfactant specifically, exhibit synergistic malodor removal.

### SUMMARY

The present disclosure relates to treatment compositions including from about 0.001 to about 3 wt % of ethoxyquin (CAS 91-53-5); ethoxyquin dimer (CAS 74681-77-9); and from about 1 wt % to about 20 wt % of nonionic surfactant.

The present disclosure also relates to a method for treating a stain on a fabric includes washing the fabric in a wash liquor including a treatment composition. The treatment composition includes from about 0.01 to about 3 wt % of ethoxyquin; ethoxyquin dimer; and from about 1 wt % to about 20 wt % of nonionic surfactant.

### DETAILED DESCRIPTION

The present disclosure relates to treatment compositions that include ethoxyquin and a nonionic surfactant. It has been found that the combination of ethoxyquin and nonionic surfactant can provide surprising malodor benefits, for example with regard to laundered fabrics.

Malodor on clothing is traditionally the result of oily body soil oxidation which eventually results in the formation and release of malodorous small molecules. The present disclosure demonstrates that the combination of non-ionic surfactant and ethoxyquin synergistically contribute to the reduction of oxidation of artificial body soil. The combination of both non-ionic surfactant and ethoxyquin produce a greater oxidation marker reduction than expected when considering the combined concentration of the nonionic surfactant and ethoxyquin. The synergy between non-ionic surfactant and ethoxyquin results in treatment compositions that more effectively control the oxidation of body soil and reduce malodor.

The compositions and processes of the present disclosure are described in more detail below.

As used herein, the articles “a” and “an” when used in a claim, are understood to mean one or more of what is claimed or described. As used herein, the terms “include,” “includes,” and “including” are meant to be non-limiting. The compositions of the present disclosure can comprise, consist essentially of, or consist of, the components of the present disclosure.

The terms “substantially free of” or “substantially free from” may be used herein. This means that the indicated material is at the very minimum not deliberately added to the composition to form part of it, or, preferably, is not present at analytically detectable levels. It is meant to include compositions whereby the indicated material is present only as an impurity in one of the other materials deliberately included. The indicated material may be present, if at all, at a level of less than 1%, or less than 0.1%, or less than 0.01%, or even 0%, by weight of the composition.

As used herein, the phrase “treatment composition” includes fabric care compositions, cleaning compositions, or combinations thereof. As used herein the phrase “fabric care composition” includes compositions and formulations designed for treating fabric. Such compositions include but are not limited to, laundry treatment compositions and detergents, fabric softening compositions, fabric enhancing compositions, fabric freshening compositions, laundry prewash, laundry pretreat, laundry additives, spray products, dry cleaning agent or composition, laundry rinse additive, wash additive, post-rinse fabric treatment, ironing aid, unit dose formulation, delayed delivery formulation, detergent contained on or in a porous substrate or nonwoven sheet, dryer sheet, and other suitable forms that may be apparent to one skilled in the art in view of the teachings herein. Such compositions may be used as a pre-laundering treatment, a post-laundering treatment, or may be added during the rinse or wash cycle of the laundering operation.

As used herein, “liquid” includes free-flowing liquids, as well as pastes, gels, foams and mousses. Non-limiting examples of liquids include light duty and heavy duty liquid detergent compositions, fabric enhancers, detergent gels commonly used for laundry, bleach and laundry additives. Gases, e.g., suspended bubbles, or solids, e.g. particles, may be included within the liquids. Liquid compositions may have from about 0% to about 90%, or from about 30% to about 90%, or from about 50% to about 80%, by weight of the composition, of water, and may include non-aqueous liquid detergents.

A “solid” as used herein includes, but is not limited to, powders, agglomerates, and mixtures thereof. Non-limiting examples of solids include: granules, micro-capsules, beads, flakes, noodles, and pearlised balls.

Unless otherwise noted, all component or composition levels are in reference to the active portion of that component or composition, and are exclusive of impurities, for example, residual solvents or by-products, which may be present in commercially available sources of such components or compositions.

All temperatures herein are in degrees Celsius (° C.) unless otherwise indicated. Unless otherwise specified, all measurements herein are conducted at 20° C. and under the atmospheric pressure.

In all examples of the present disclosure, all percentages are by weight of the total composition, unless specifically stated otherwise. All ratios are weight ratios, unless specifically stated otherwise.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

### Treatment Composition

The present disclosure relates to treatment compositions that are suitable for treating a surface. The treatment compositions may contain an antioxidant, typically at a relatively low level, and additional treatment adjuncts. The treatment composition may be a fabric care composition, such as a laundry detergent composition.

The compositions of the present disclosure may be fabric care compositions. Such compositions may be used as a pre-laundering treatment, a post-laundering treatment, or may be added during the rinse or wash cycle of the laundering operation. It may also be used in a dry cleaning context.

The composition may be selected from the group of light duty liquid detergents compositions, heavy duty liquid detergent compositions, detergent gels commonly used for laundry, bleaching compositions, laundry additives, fabric enhancer compositions, and mixtures thereof. The composition may be a heavy duty liquid detergent composition or a fabric enhancer composition. The composition may be intended to be used during a wash cycle and/or during a rinse cycle of an automatic washing machine.

The treatment composition may be a hard surface cleaner, suitable for treating hard surfaces such as tile, porcelain, countertops, and the like.

The composition may be in any suitable form. The composition may be in the form of a liquid composition, a granular composition, a single-compartment pouch, a multi-compartment pouch, a dissolvable sheet, a pastille or bead, a fibrous article, a tablet, a bar, a flake, a dryer sheet, or a mixture thereof. The composition can be selected from a liquid, solid, or combination thereof.

The treatment composition may be in the form of a unitized dose article, such as a tablet, a pouch, a sheet, or a fibrous article. Such pouches typically include a water-soluble film, such as a polyvinyl alcohol water-soluble film, that at least partially encapsulates a composition. Suitable films are available from MonoSol, LLC (Indiana, USA). The composition can be encapsulated in a single or multi-compartment pouch. A multi-compartment pouch may have at least two, at least three, at least four compartments, at least five compartments, or at least six or more compartments. A multi-compartmented pouch may include compartments that are side-by-side and/or superposed. The composition contained in the pouch or compartments thereof may be liquid, solid (such as powders), or combinations thereof. Pouched compositions may have relatively low amounts of water, for example less than about 20%, or less than about 15%, or less than about 12%, or less than about 10%, or less than about 8%, by weight of the detergent composition, of water.

The ethoxyquin and nonionic surfactant and additional treatment adjuncts of the present disclosure are described in more detail below.

### Ethoxyquin

The treatment compositions of the present disclosure include an antioxidant, such as ethoxyquin. One non-limiting, commercially available, version of ethoxyquin (1,2-dihydro-6-ethoxy-2,2,4-trimethylquinoline; CAS 91-53-2) is marketed under the name Capsoquin™ by the company ITPSA™ (Industrial Técnica Pecuaria, S.A.).

Without wishing to be bound by theory, it is believed that antioxidants that are able to reduce clothing malodor deposit effectively on the fabric surface during the wash cycle and intercalate in the fabric/soil/surfactant matrix in a manner that does not inhibit the antioxidant's ability to donate electrons to (and neutralize) local reactive oxygen species (ROS) (it is well known that ROS react with soil to cause malodor). Several antioxidants have been evaluated with the “Malodor Reduction Test Method” including hesperidine (CAS 520-26-3), diosemetin (CAS 520-34-3), quinacridone (CAS 1047-16-1), neohesperidin dihydrochalcone (CAS 20702-77-6) and were not effective at reducing oxidation markers. Surprisingly, ethoxyquin, when evaluated using the “Malodor Reduction Test Method,” was effective at reducing oxidation markers indicating it possesses unique and unexpected fabric deposition properties during the wash cycle.

The treatment composition may include from 0.001 to 3 wt %, from 0.001 to 2 wt %, from 0.001 to 1 wt %, from 0.001 to 0.5 wt %, from 0.001 to 0.3 wt %, from 0.001 to 0.2 wt %, from 0.01 to 3 wt %, from 0.01 to 2 wt %, from 0.01 to 1 wt %, from 0.01 to 0.5 wt %, from 0.01 to 0.3 wt %, from 0.01 to 0.2 wt %, from 0.02 to 3 wt %, from 0.02 to 2 wt %, from 0.02 to 1 wt %, from 0.02 to 0.5 wt %, from 0.02 to 0.3 wt %, from 0.02 to 0.2 wt %, or any values within the foregoing ranges or any ranges created thereby, of ethoxyquin.

The treatment compositions of the present disclosure may further include ethoxyquin dimer (CAS 74681-77-9). Ethoxyquin dimer forms when two molecules of ethoxyquin combine through a covalent bond. The dimerization of ethoxyquin occurs when two ethoxyquin molecules react, resulting in the formation of a more complex structure. The ethoxyquin dimer possesses distinct chemical properties compared to its monomeric counterpart. It exhibits altered solubility, stability, and reactivity due to the formation of the covalent bond between the two ethoxyquin molecules. The dimerization process can lead to changes in the antioxidant activity of ethoxyquin, influencing its effectiveness in preventing oxidative degradation.

The treatment composition may include from 1 to 1000 ppm, from 1 to 100 ppm, from 1 to 10 ppm, from 1 to 8 ppm, from 1 to 6 ppm, from 1 to 4 ppm, from 1 to 3 ppm, from 1.5 to 10 ppm, from 1.5 to 8 ppm, from 1.5 to 6 ppm, from 1.5 to 4 ppm, from 1.5 to 3 ppm, from 2 to 10 ppm, from 2 to 8 ppm, from 2 to 6 ppm, from 2 to 4 ppm, from 2 to 3 ppm, or any values within the foregoing ranges or any ranges created thereby, of ethoxyquin dimer.

### Nonionic Surfactant

A nonionic surfactant may include an alcohol alkoxylate, an oxo-synthesized alcohol alkoxylate, a Guerbet alcohol alkoxylate, an alkyl phenol alcohol alkoxylate, an alkylpolyglucoside, or a mixture thereof. Preferably, a non-ionic surfactant may include, for example, alkoxylated alcohol nonionic surfactants, alkyl polyglucoside nonionic surfactants, and mixtures thereof. Preferably, the alkoxylated alcohol non-ionic surfactant may be a linear or branched, primary or secondary alkyl alkoxylated non-ionic surfactant, preferably may be an alkyl alkoxylated non-ionic surfactant, preferably may be an alkyl ethoxylated non-ionic surfactant, preferably may include on average from about 9 to about 15, preferably from about 10 to about 16, more preferably from about 12 to about 15, carbon atoms in its alkyl chain; and on average from about 5 to about 12, preferably from about 6 to about 10, most preferably from about 7 to about 8 or from about 9 to about 10, units of ethylene oxide per mole of alcohol. For example, one non-ionic surfactant useful in the compositions defined herein may include an ethoxylated non-ionic surfactant with an average carbon chain length of about 10 to about 16. Such non-ionic surfactant may comprise: 1) an ethoxylated nonionic surfactant with an average carbon chain length of about 12 to about 14 and an average level of ethoxylation of about 9, and 2) a second ethoxylated nonionic surfactant with an average carbon chain length of about 14 to about 15 and an average ethoxylation of about 7.

The nonionic surfactant may have the formula R(OC₂H₄)ₙOH, wherein R is selected from the group consisting of aliphatic hydrocarbon radicals containing from about 8 to about 16 carbon atoms and can be linear or branched and the average value of n is from about 5 to about 15. For example, the additional nonionic surfactant may be selected from ethoxylated alcohols having an average of about 12-14 carbon atoms in the alcohol (alkyl) portion and an average degree of ethoxylation of about 7-9 moles of ethylene oxide per mole of alcohol.

Additional non limiting examples include ethoxylated alkyl phenols of the formula R(OCH₄)ₙOH, wherein R comprises an alkyl phenyl radicals in which the alkyl groups contain from about 8 to about 12 carbon atoms, and the average value of n is from about 5 to about 15, C₁₂-C₁₈ alkyl ethoxylates, such as, NEODOL® nonionic surfactants from Shell; C₁₄-C₂₂ mid-chain branched alcohols; C₁₄-C₂₂ mid-chain branched alkyl ethoxylates, BAEₓ, wherein x is from 1 to 30. The nonionic ethoxylated alcohol surfactant herein may further comprise residual alkoxylation catalyst, which may be considered residue from the reaction or an impurity. It may further comprise various impurities or by-products of the alkoxylation reaction. The impurities may vary depending on the catalyst used and the conditions of the reaction. Impurities include alkyl ethers, e.g., dialkyl ethers, such as, didodecyl ether, glycols, e.g., diethylene glycol, triethylene glycol, pentaethylene glycol, other polyethylene glycols.

The nonionic ethoxylated alcohol may be a narrow range ethoxylated alcohol. A narrow range ethoxylated alcohol may have the following general formula (I):

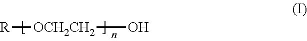

where R is selected from a saturated or unsaturated, linear or branched, C₁₀-C₁₆ alkyl group and where greater than 90% of n is 0≤n≤15. In addition, the average value of n can be between about 4 to about 14, preferably about 6 to about 10, where less than about 10% by weight of the alcohol ethoxylate are ethoxylates having n<7 and between 10% and about 20% by weight of the alcohol ethoxylate are ethoxylates having n=8.

The composition may comprise an average value of n of about 10. The composition may have the following ranges for each of the following n: n=0 of up to 5%, each of n=1, 2, 3, 4, 5 of up to 2%, n=6 of up to 4%, n=7 of up to 10%, n=8 of between 12% and 20%, n=9 of between 15% and 25%, n=10 of between 15% to 30%, n=11 of between 10% and 20%, n=12 of up to 10%, and n>12 at up to 10%. The composition may have n=9 to 10 of between 30% and 70%. The composition may have greater than 50% of its composition made up of n=8 to 11.

R can be selected from a saturated or unsaturated, linear or branched, C10-C16 alkyl group, where the average value of n is between about 6 and about 10. R can also be selected from a saturated or unsaturated, linear or branched, C₈-C₁₆ alkyl group, where greater than 90% of n is 0≤n≤15, and where the average value of n between about 5 to about 10, where less than about 20% by weight of the alcohol ethoxylate are ethoxylates having n<8. R can also be selected from a saturated or unsaturated, linear or branched, C₁₀-C₁₆ alkyl group, where greater than 90% of n is 0≤n≤15, and where the average value of n between about 6 to about 10, where less than about 10% by weight of the alcohol ethoxylate are ethoxylates having n<7 and between 10% and about 20% by weight of the alcohol ethoxylate are ethoxylates having n=8.

The alcohol ethoxylates described herein are typically not single compounds as suggested by their general formula (I), but rather, they comprise a mixture of several homologs having varied polyalkylene oxide chain length and molecular weight. Among the homologs, those with the number of total alkylene oxide units per mole of alcohol closer to the most prevalent alkylene oxide adduct are desirable; homologs whose number of total alkylene oxide units is much lower or much higher than the most prevalent alkylene oxide adduct are less desirable. In other words, a “narrow range” or “peaked” alkoxylated alcohol composition is desirable. A “narrow range” or “peaked” alkoxylated alcohol composition refers to an alkoxylated alcohol composition having a narrow distribution of alkylene oxide addition moles.

A “narrow range” or “peaked” alkoxylated alcohol composition may be desirable for a selected application. Homologs in the selected target distribution range may have the proper lipophilic-hydrophilic balance for a selected application. For example, in the case of an ethoxylated alcohol product comprising an average ratio of 5 ethylene oxide (EO) units per molecule, homologs having a desired lipophilic-hydrophilic balance may range from 2EO to 9EO. Homologs with shorter EO chain length (<2EO) or longer EO chain length (>9EO) may not be desirable for the applications for which a =5 EO/alcohol ratio surfactant is ordinarily selected since such longer and shorter homologs are either too lipophilic or too hydrophilic for the applications utilizing this product. Therefore, it is advantageous to develop an alkoxylated alcohol having a peaked distribution.

The narrow range alkoxylated alcohol compositions of the disclosure may have an average degree of ethoxylation ranging from about 0 to about 15, such as, for example, ranging from about 4 to about 14, from about 5-10, from about 8-11, and from about 6-9. The narrow range alkoxylated alcohol compositions of the disclosure may have an average degree of ethoxylation of 10. The narrow range alkoxylated alcohol compositions of the disclosure may have an average degree of ethoxylation of 9. The narrow range alkoxylated alcohol compositions of the disclosure may have an average degree of ethoxylation of 5.

The alkyl polyglucoside surfactant can be selected from C10-C16 alkyl polyglucoside surfactant. The alkyl polyglucoside surfactant can have a number average degree of polymerization of from 0.1 to 3.0, preferably from 1.0 to 2.0, more preferably from 1.2 to 1.6. The alkyl polyglucoside surfactant can comprise a blend of short chain alkyl polyglucoside surfactant having an alkyl chain comprising 10 carbon atoms or less, and mid to long chain alkyl polyglucoside surfactant having an alkyl chain comprising greater than 10 carbon atoms to 18 carbon atoms, preferably from 12 to 14 carbon atoms.

Short chain alkyl polyglucoside surfactants have a monomodal chain length distribution between C8-C10, mid to long chain alkyl polyglucoside surfactants have a monomodal chain length distribution between C10-C18, while mid chain alkyl polyglucoside surfactants have a monomodal chain length distribution between C12-C14. In contrast, C8 to C18 alkyl polyglucoside surfactants typically have a monomodal distribution of alkyl chains between C8 and C18, as with C8 to C16 and the like. As such, a combination of short chain alkyl polyglucoside surfactants with mid to long chain or mid chain alkyl polyglucoside surfactants have a broader distribution of chain lengths, or even a bimodal distribution, than non-blended C8 to C18 alkyl polyglucoside surfactants. Preferably, the weight ratio of short chain alkyl polyglucoside surfactant to long chain alkyl polyglucoside surfactant is from 1:1 to 10:1, preferably from 1.5:1 to 5:1, more preferably from 2:1 to 4:1. It has been found that a blend of such short chain alkyl polyglucoside surfactant and long chain alkyl polyglucoside surfactant results in faster dissolution of the detergent solution in water and improved initial sudsing, in combination with improved suds stability.

C10-C16 alkyl polyglucosides are commercially available from several suppliers (e.g., Simusol® surfactants from Seppic Corporation; and Glucopon® 600 CSUP, Glucopon® 650 EC, Glucopon® 600 CSUP/MB, and Glucopon® 650 EC/MB, from BASF Corporation). Glucopon® 215UP is a preferred short chain APG surfactant. Glucopon® 600CSUP is a preferred mid to long chain APG surfactant.

It is believed that the combination of ethoxyquin and nonionic surfactant improves the deposition of ethoxyquin to the fabric surface. Without intending to be bound by theory, an increased concentration of ethoxyquin on the fabric surface, even in a transient manner, may decrease the average proximity between ethoxyquin and the malodor causing soil. It is contemplated that ethoxyquin in close proximity to the soil will neutralize local ROS that would have otherwise reacted with the soil and caused malodor.

### Additional Treatment Adjunct

The treatment compositions of the present disclosure may include an additional treatment adjunct. The additional treatment adjuncts may be suitable for delivering a treatment benefit to a target surface, such as a fabric or other textile. Treatment adjuncts, as used herein, may also include agents that facilitate chemical or physical stability in the treatment compositions, such as buffers, structurants/thickeners, and/or carriers.

The treatment adjunct(s) may be present in the composition at levels suitable for the intended use of the composition. Typical usage levels range from as low as 0.001% by weight of composition for adjuncts such as optical brighteners to 50% by weight of composition for surfactants.

The treatment adjunct may include a surfactant system, antioxidant, hueing agent, optical brightener, additional chelating agents, enzymes, fatty acids and/or salts thereof, encapsulated benefit agents, soil release polymers, builders, dye transfer inhibiting agents, dispersants, enzyme stabilizers, catalytic materials, bleaching agents, bleach catalysts, bleach activators, polymeric dispersing agents, soil removal/anti-redeposition agents, polymeric grease cleaning agents, amphiphilic copolymers, suds suppressors, aesthetic dyes, perfume (including encapsulated perfume), structure elasticizing agents, fabric softeners, carriers, fillers, hydrotropes, solvents, anti-microbial agents and/or preservatives, neutralizers and/or pH adjusting agents, processing aids, fillers, rheology modifiers or structurants, opacifiers, pearlescent agents, pigments, anti-corrosion and/or anti-tarnishing agents, antifoams, chlorine scavengers, and mixtures thereof.

The treatment adjunct may include a surfactant system, an antioxidant, a whitening or brightening agents such as a hueing agent or an optical brightener, an additional chelant, an enzyme, or mixtures thereof. The additional adjunct may include an encapsulated benefit agent, which may be encapsulated perfume, preferably where the encapsulated perfume comprises a shell surrounding a core, preferably where the shell comprises amine compounds and/or acrylate polymers.

Several treatment adjuncts are discussed in more detail below.

### Surfactant System

Compositions according to the present disclosure may include a surfactant system. The surfactant system may consist of one type of surfactant. The surfactant system may include more than one surfactant. In particular, laundry detergents (such as heavy duty liquid laundry detergents) may include surfactant systems, including systems that include anionic surfactant.

The compositions of the present disclosure may include from about from about 1% to about 90%, or from about 1% to about 80%, or from about 1% to about 70%, or from about 2% to about 60%, or from about 5% to about 50%, by weight of the composition, of a surfactant system. Liquid compositions may include from about 5% to about 40%, by weight of the composition, of a surfactant system. Compact formulations, including compact liquids, gels, and/or compositions suitable for a unit dose form, may include from about 25% to about 90%, or from about 25% to about 70%, or from about 30% to about 50%, by weight of the composition, of a surfactant system.

The surfactant system may include anionic surfactant, nonionic surfactant, zwitterionic surfactant, cationic surfactant, amphoteric surfactant, or combinations thereof. The surfactant system may include linear alkyl benzene sulfonate, alkyl ethoxylated sulfate, alkyl sulfate, alkyl ethoxylated carboxylates, nonionic surfactant such as ethoxylated alcohol, amine oxide, or mixtures thereof. The surfactants may be, at least in part, derived from natural sources, such as natural feedstock alcohols.

The surfactant system may include anionic surfactant. Suitable anionic surfactants may include any conventional anionic surfactant. This may include a sulfate detersive surfactant, for e.g., alkoxylated and/or non-alkoxylated alkyl sulfate materials, and/or sulfonic detersive surfactants, e.g., alkyl benzene sulfonates. The anionic surfactants may be linear, branched, or combinations thereof. Preferred surfactants include linear alkyl benzene sulfonate (LAS), alkyl ethoxylated sulfate (AES), alkyl sulfates (AS), or mixtures thereof. Other suitable anionic surfactants include branched modified alkyl benzene sulfonates (MLAS), methyl ester sulfonates (MES), and/or alkyl ethoxylated carboxylates (AEC). The anionic surfactants may be present in acid form, salt form, or mixtures thereof. The anionic surfactants may be neutralized, in part or in whole, for example, by an alkali metal (e.g., sodium) or an amine (e.g., monoethanolamine). The anionic surfactant may be pre-neutralized, preferably with an alkali metal, an alkali earth metal, an amine such as an ethanolamine, or mixtures thereof. While AES is a suitable anionic surfactant, in some configurations, the compositions of the present disclosure may be substantially free of AES and/or ethoxylated sulfate surfactants.

The surfactant system may include nonionic surfactant. Suitable nonionic surfactants include alkoxylated fatty alcohols, such as ethoxylated fatty alcohols. Other suitable nonionic surfactants include alkoxylated alkyl phenols, alkyl phenol condensates, mid-chain branched alcohols, mid-chain branched alkyl alkoxylates, alkylpolysaccharides (e.g., alkylpolyglycosides), polyhydroxy fatty acid amides, ether capped poly(oxyalkylated) alcohol surfactants, and mixtures thereof. The alkoxylate units may be ethyleneoxy units, propyleneoxy units, or mixtures thereof. The nonionic surfactants may be linear, branched (e.g., mid-chain branched), or a combination thereof. Specific nonionic surfactants may include alcohols having an average of from about 12 to about 16 carbons, and an average of from about 3 to about 9 ethoxy groups, such as C12-C14 EO7 nonionic surfactant.

Suitable zwitterionic surfactants may include any conventional zwitterionic surfactant, such as betaines, including alkyl dimethyl betaine and cocodimethyl amidopropyl betaine, C₈ to C₁₈ (for example from C₁₂ to C₁₈) amine oxides (e.g., C₁₂₋₁₄ dimethyl amine oxide), and/or sulfo and hydroxy betaines, such as N-alkyl-N,N-dimethylammino-1-propane sulfonate where the alkyl group can be C₈ to C₁₈, or from C₁₀ to C₁₄. The zwitterionic surfactant may include amine oxide.

### Fabric Conditioning Active

The treatment compositions of the present disclosure may include a fabric conditioning active (FCA). Compositions comprising such actives, such as liquid fabric enhancing compositions, may be useful for providing various benefits to target fabrics, including softness, anti-wrinkle, anti-static, conditioning, anti-stretch, color and/or appearance benefits. Fabric conditioning actives (FCAs) suitable for compositions of the present disclosure may include quaternary ammonium ester compounds, silicones, non-ester quaternary ammonium compounds, amines, fatty esters, sucrose esters, silicones, dispersible polyolefins, polysaccharides, fatty acids, softening or conditioning oils, polymer latexes, or combinations thereof.

### Antioxidant

The compositions of the present disclosure may include an antioxidant. Without wishing to be bound by theory, it is believed that antioxidants may help to improve malodor control and/or cleaning performance of the compositions. Antioxidants may also help to reduce yellowing that may be associated with amines, allowing the amines to be formulated at a relatively higher level. Antioxidants are substances as described in Kirk-Othmer (Vol. 3, page 424) and in Ullmann's Encyclopedia (Vol. 3, page 91).

The compositions of the present disclosure may include an antioxidant, preferably a hindered phenol antioxidant, in an amount of from about 0.001% to about 2%, preferably from about 0.01% to about 0.5%, by weight of the composition.

Suitable antioxidants may include alkylated phenols, having the general formula:

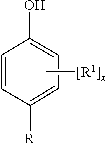

wherein R is C₁-C₂₂ linear alkyl or C₃-C₂₂ branched alkyl, each (1) having optionally therein one or more ester (—CO₂—) or ether (—O—) links, and (2) optionally substituted by an organic group comprising an alkyleneoxy or polyalkyleneoxy group selected from EO (ethoxy), PO (propoxy), BO (butoxy), and mixtures thereof, more preferably from EO alone or from EO/PO mixtures; R may preferably be methyl, branched C₃-C₆ alkyl, or C₁-C₆ alkoxy, preferably methoxy; R¹ is a C₃-C₆ branched alkyl, preferably tert-butyl; x is 1 or 2.

Preferred types of alkylated phenols having this formula may include hindered phenolic compounds. As used herein, the term “hindered phenol” is used to refer to a compound comprising a phenol group with either (a) at least one C₃ or higher branched alkyl, preferably a C₃-C₆ branched alkyl, preferably tert-butyl, attached at a position ortho to at least one phenolic —OH group, or (b) substituents independently selected from the group consisting of a C₁-C₆ alkoxy, preferably methoxy, a C₁-C₂₂ linear alkyl or C₃-C₂₂ branched alkyl, preferably methyl or branched C₃-C₆ alkyl, or mixtures thereof, at each position ortho to at least one phenolic —OH group. If a phenyl ring comprises more than one —OH group, the compound is a hindered phenol provided at least one such —OH group is substituted as described immediately above. Where any R group in the structure above comprises three or more contiguous monomers, that antioxidant is defined herein as a “polymeric hindered phenol antioxidant.” Compositions according to the present disclosure may include a hindered phenol antioxidant. A preferred hindered phenol antioxidant includes 3,5-di-tert-butyl-4-hydroxytoluene (BHT).

A further class of hindered phenol antioxidants that may be suitable for use in the composition is a benzofuran or benzopyran derivative having the formula:

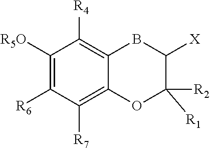

wherein R¹ and R² are each independently alkyl or R¹ and R² can be taken together to form a C₅-C₆ cyclic hydrocarbyl moiety; B is absent or CH₂; R⁴ is C₁-C₆ alkyl; R⁵ is hydrogen or —C(O)R³ wherein R³ is hydrogen or C₁-C₁₉ alkyl; R⁶ is C₁-C₆ alkyl; R⁷ is hydrogen or C₁-C₆ alkyl; X is —CH₂OH, or —CH₂A wherein A is a nitrogen-comprising unit, phenyl, or substituted phenyl. Preferred nitrogen-comprising A units include amino, pyrrolidino, piperidino, morpholino, piperazino, and mixtures thereof.

Suitable hindered phenol antioxidants may include: 2,6-bis(1,1-dimethylethyl)-4-methyl-phenol; 3,5-bis(1,1-dimethylethyl)-4-hydroxy-benzenepropanoic acid, methyl ester; 3,5-bis(1,1-dimethylethyl)-4-hydroxybenzenepropanoic acid, octadecyl ester; or mixtures thereof.

Commercially available antioxidants that may be suitable include BHT, RALOX 35™, and/or TINOGARD TS™.

Additional antioxidants may be employed. Examples of suitable antioxidants for use in the composition include, but are not limited to, the group consisting of α-, β-, γ-, δ-tocopherol, ethoxyquin, 2,2,4-trimethyl-1,2-dihydroquinoline, 2,6-di-tert-butyl hydroquinone, tert-butyl hydroxyanisole, lignosulphonic acid and salts thereof, and mixtures thereof. It is noted that ethoxyquin (1,2-dihydro-6-ethoxy-2,2,4-trimethylquinoline) is marketed under the name Capsoquin™ by the company ITPSA™. Other types of antioxidants that may be used in the composition are 6-hydroxy-2,5,7,8-tetramethylchroman-2-carboxylic acid (Trolox™) and 1,2-benzisothiazoline-3-one (Proxel GXL™). Antioxidants such as tocopherol sorbate, butylated hydroxyl benzoic acids and their salts, gallic acid and its alkyl esters, uric acid and its salts, sorbic acid and its salts, and dihydroxyfumaric acid and its salts may also be useful. Other useful antioxidants may include tannins, such as tannins selected from the group consisting of gallotannins, ellagitannins, complex tannins, condensed tannins, and combinations thereof.

The use of non-yellowing antioxidants, such as non-yellowing hindered phenol antioxidants, may be preferred. Antioxidants that form such yellow by-products may be avoided if they lead to perceptible negative attributes in the consumer experience (such as deposition of yellow by-products on fabric, for example). The skilled artisan is able to make informed decisions regarding the selection of antioxidants to employ.

### Whitening/Brightening Agent

The additional treatment adjuncts of the present disclosure may include a whitening or brightening agent. Such agents may be selected from a hueing agent, an optical brightener, or mixtures thereof. The use of such agents may further reduce the effects of discoloration or yellowing.

The compositions of the present disclosure may include a hueing agent. It has surprisingly been found that graft polymers according to the present disclosure may inhibit transfer of fugitive dyes, while having little effect on the deposition and/or performance of hueing agents on target fabrics.

Hueing agents (sometimes referred to as hueing dyes, fabric shading dyes, or bluing or whitening agents) typically provides a blue or violet shade to fabric. Such agent(s) are well known in the art and may be used either alone or in combination to create a specific shade of hueing and/or to shade different fabric types. The hueing agent may be selected from any suitable chemical class of dye as known in the art, including but not limited to acridine, anthraquinone (including polycyclic quinones), azine, azo (e.g., monoazo, disazo, trisazo, tetrakisazo, polyazo), benzodifurane, benzodifuranone, carotenoid, coumarin, cyanine, diazahemicyanine, diphenylmethane, formazan, hemicyanine, indigoids, methane, naphthalimides, naphthoquinone, nitro, nitroso, oxazine, phthalocyanine, pyrazoles, stilbene, styryl, triarylmethane, triphenylmethane, xanthenes and mixtures thereof. The hueing agent may be selected from an azo agent, a triarylmethane agent, a triphenylmethane agent, or mixtures thereof.

Suitable hueing agents include fabric shading dyes such as small molecule dyes, polymeric dyes, and dye-clay conjugates. Preferred fabric shading dyes are selected from small molecule dyes and polymeric dyes. Suitable small molecule dyes may be selected from the group consisting of dyes falling into the Colour Index (C.I., Society of Dyers and Colourists, Bradford, UK) classifications of Acid, Direct, Basic, Reactive, Solvent or Disperse dyes.

Suitable polymeric dyes include dyes selected from the group consisting of polymers containing covalently bound (sometimes referred to as conjugated) chromogens, (also known as dye-polymer conjugates), for example polymers with chromogen monomers co-polymerized into the backbone of the polymer and mixtures thereof. Preferred polymeric dyes comprise the optionally substituted alkoxylated dyes, such as alkoxylated triphenyl-methane polymeric colourants, alkoxylated carbocyclic and alkoxylated heterocyclic azo colourants including alkoxylated thiophene polymeric colourants, and mixtures thereof, such as the fabric-substantive colorants sold under the name of Liquitint® (Milliken, Spartanburg, South Carolina, USA).

Suitable dye clay conjugates include dye clay conjugates selected from the group comprising at least one cationic/basic dye and a smectite clay; a preferred clay may be selected from the group consisting of Montmorillonite clay, Hectorite clay, Saponite clay and mixtures thereof.

Pigments are well known in the art and may also be used as hueing agents in the fabric care compositions disclosed herein. Suitable pigments may include C.I Pigment Blues 15 to 20, especially 15 and/or 16, C.I. Pigment Blue 29, C.I. Pigment Violet 15, Monastral Blue, and mixtures thereof.

The amount of adjunct hueing agent present in a laundry care composition of the present disclosure may be from 0.0001 to 0.05 wt % based on the total treatment composition, preferably from 0.0001 to 0.005 wt %. Based on the wash liquor, the concentration of hueing agent may be from 1 ppb to 5 ppm, preferably from 10 ppb to 500 ppb.

The compositions of the present disclosure may include an optical brightener. Brighteners, also sometimes referred to as fluorescent whitening agents, may emit at least some visible light.

Commercial optical brighteners, which may be used herein, can be classified into subgroups, which include, but are not necessarily limited to, derivatives of stilbene, pyrazoline, coumarin, carboxylic acid, methinecyanines, dibenzothiphene-5,5-dioxide, azoles, 5- and 6-membered-ring heterocycles, and other miscellaneous agents. The brighteners may be added in particulate form or as a premix with a suitable solvent, for example nonionic surfactant, monoethanolamine, and/or propane diol.

Suitable fluorescent brighteners may include: disodium 4,4′-bis {[4-anilino-6-morpholino-s-triazin-2-yl]-amino}-2,2′-stilbenedisulfonate (Brightener 15, commercially available under the tradename Tinopal AMS-GX by BASF); disodium 4,4′-bis {[4-anilino-6-(N-2-bis-hydroxyethyl)-s-triazine-2-yl]-amino}-2,2′-stilbenedisulonate (commercially available under the tradename Tinopal UNPA-GX by BASF); disodium 4,4′-bis {[4-anilino-6-(N-2-hydroxyethyl-N-methylamino)-s-triazine-2-yl]-amino}-2,2′-stilbenedisulfonate (commercially available under the tradename Tinopal 5BM-GX by BASF); and/or disodium 4,4′-bis((4-amino-6-anilino-1,3,5-triazin-2-yl)amino)stilbene-2,2′-disulphonate (Brightener 49). The brightener may be Brightener 49, Brightener 15, Brightener 3, or mixtures thereof.

### Additional Chelating Agent

The additional treatment adjuncts of the present disclosure may comprise a chelating agent (also known as a chelant or a chelator).

The chelating agent may be present at a level of from about 0.1% to about 10%, or to about 5%, or to about 2%, by weight of the composition. The chelating agent(s) may be present in the treatment composition at a combined level of from about 0.1% to about 10%, preferably to about 5%, by weight of the treatment composition.

Suitable chelating agents may include phosphonates, aminocarboxylates, amino phosphonates, polyfunctionally-substituted aromatic chelating agents, or mixtures thereof, preferably aminocarboxylates. The additional chelating agents, as used herein, are not intended to include traditional builders, such as citric acid, although such builders may be present in compositions of the present disclosure.

Aminocarboxylates useful as chelating agents include, but are not limited to, ethylenediaminetetracetates, N-(hydroxyethyl)ethylenediaminetriacetates, nitrilotriacetates, ethylenediamine tetraproprionates, triethylenetetraaminehexacetates, diethylenetriamine-pentaacetates, and ethanoldiglycines, alkali metal, ammonium, and substituted ammonium salts thereof, and mixtures thereof. Aminophosphonates are also suitable for use as chelating agents in the compositions of the present disclosure when low levels of total phosphorus are permitted, and include ethylenediaminetetrakis (methylenephosphonates). Polyfunctionally-substituted aromatic chelating agents may include catechols, for example sulphonated catechols.

The chelant may include: DETA, DTPA (diethylenetriaminepentaacetic acid), HEDP (hydroxyethanediphosphonic acid), EDDS (ethylenediamine disuccinate (EDDS), DTPMP (diethylene triamine penta (methylene phosphonic acid)), EDTMP (ethylene diamine tetra(methylene phosphonic acid)), Tiron® (1,2-diydroxybenzene-3,5-disulfonic acid), HPNO (2-pyridinol-N-oxide), MGDA (methylglycinediacetic acid), GLDA (glutamic-N,N-diacetic acid), any suitable derivative thereof, salts thereof, and mixtures thereof.

### Enzymes

The treatment compositions of the present disclosure may include one or more enzymes that provide cleaning performance and/or fabric care benefits. Examples of suitable enzymes include, but are not limited to, hemicellulases, peroxidases, proteases, cellulases, xylanases, lipases, phospholipases, esterases, cutinases, pectinases, mannanases, pectate lyases, keratinases, reductases, oxidases, phenoloxidases, lipoxygenases, ligninases, pullulanases, tannases, pentosanases, malanases, β-glucanases, arabinosidases, hyaluronidase, chondroitinase, laccase, amylases, nucleases (such as deoxyribonuclease and/or ribonuclease), phosphodiesterases, or mixtures thereof. Particularly preferred may be a mixture of protease, amylase, lipase, cellulase, phosphodiesterase, and/or pectate lyase.

### Other Agents

The treatment compositions of the present disclosure may include solvent, preferably organic solvent, such as a non-aminofunctional organic solvent. Suitable organic solvents may include glycerol, ethylene glycol, 1,3 propanediol, 1,2 propanediol, tetramethylene glycol, pentamethylene glycol, hexamethylene glycol, 2,3-butane diol, 1,3 butanediol, diethylene glycol, triethylene glycol, polyethylene glycol, glycerol formal dipropylene glycol, polypropylene glycol, dipropylene glycol n-butyl ether, and mixtures thereof.

The treatment compositions of the present disclosure may include chlorine scavengers. It is believed that chlorine ions in a treatment liquor, for example from hypochlorite bleach or naturally occuring in the water source, may contribute to color fading or other discoloration. A chlorine scavenger may be incorporated at a level adequate to neutralize at least about 1 ppm, or at least about 2 ppm, or at least about 5 ppm, or at least about 10 ppm chlorine in a treatment liquor. Chlorine scavengers may include amines and/or ammonium salts. Preferred amines may include those that comprise primary and/or secondary amines, and may include alkanolamines such as monoethanolamine (MEA), diethanolamine (DEA), and/or triethanolamine (TEA).

The treatment compositions of the present disclosure may contain cleaning and/or dispersing polymers, which may provide cleaning and/or whiteness benefits. Suitable cleaning and/or dispersing polymers may include: polymeric soil release agents, which may be anionic or nonionic and/or may include a terephthalate moiety; alkoxylated polyamines, such as ethoxylated and/or propoxylated polyethyleneimines (such as PEI600 EO20 and/or PEI EO24 PO16), ethoxylated hexamethylene diamines, and sulfated versions thereof; alkoxylated polycarboxylates, including those derived from polyacrylates; amphiphilic graft co-polymers, such as those derived from a polyethylene glycol backbone and having at least one pendant moiety selected from polyvinyl acetate, polyvinyl alcohol, or mixtures thereof (such as Sokalan HP22); cellulosic polymers, such as carboxymethyl cellulose, methyl cellulose, methyl hydroxyethyl cellulose, methyl carboxymethyl cellulose, and mixtures thereof; carboxylate polymers, such as a maleate/acrylate random copolymer or polyacrylate homopolymer; or mixtures thereof. Cellulosic polymers and/or carboxylate polymers may be particularly useful in dry or powdered treatment compositions, as they may be more difficult to formulate in liquid and gel forms. It may be desirable to limit or even eliminate certain adjuncts, particularly if a detergent sourced primarily from natural or sustainable sources is desired. The detergent compositions of the present disclosure may be free of silicone, dye, brightener, or combinations thereof. The detergent compositions of the present disclosure may comprise less than 5%, or less than 3%, or less than 1%, by weight of the composition, of amine-containing compounds, with the proviso that amine oxide surfactant (if present) is not included in the total amount of amine-containing compounds.

The compositions of the present disclosure may be substantially free of selenium compounds. The compositions of the present disclosure may be substantially free of haloproparagyl compounds.

### Method of Making a Composition

The present disclosure relates to methods of making fabric care compositions comprising the antioxidants described herein. The method may include combining the components of the compositions described herein in the proportions described. For example, a antioxidant according to the present disclosure may be provided and combined with at least one additional treatment adjunct to form a treatment composition.

Liquid compositions according to the present disclosure may be made according to conventional methods, for example in a batch process or in a continuous loop process.

Solid compositions according to the present disclosure may be made according to conventional methods, for example by spray-drying process or in an agglomeration process.

The detergent compositions described herein may be encapsulated in a pouch, preferably a pouch made of water-soluble film, to form a unit dose article that may be used to treat fabrics. The pouch may include one compartment, or may have multiple compartments, which may be side-by-side and/or superposed. It may be preferred that such compositions have relatively low amounts of water, for example less than about 20%, or less than about 15%, or less than about 12%, or less than about 10%, or less than about 8%, by weight of the detergent composition, of water.

### Method of Using Compositions

The present disclosure relates to methods of using the compositions described herein. The detergent compositions may be a fabric care composition and may be used to treat a surface, such as a fabric or other textile.

Methods of treating a surface may include the steps of: providing a surface, preferably a fabric, and contacting the surface with a composition according to the present disclosure, as described above. The method may include agitating the fabric in the presence of water. The method may further comprise the step of carrying out a washing or cleaning operation. Water may be added before, during, or after the contacting step to form a treatment liquor. The water and/or the treatment liquor may include copper ions (Cu²⁺), for example at a level of from about 0.1 ppm to about 25 ppm.

The present disclosure also relates to a process for treating, for example by machine, a fabric, preferably soiled fabric, using a composition according to the present disclosure, comprising the steps of, placing a composition according to the present disclosure into contact with the fabric to be treated, and carrying out a treatment operation, such as a washing, cleaning, or fabric-enhancing operation. The contacting step may occur during the wash cycle or during the rinse cycle of an automatic washing machine.

Any suitable washing machine may be used, for example, a top-loading or front-loading automatic washing machine. Those skilled in the art will recognize suitable machines for the relevant treatment operation. The article of the present disclosure may be used in combination with other compositions, such as fabric additives, fabric softeners, rinse aids, and the like. Additionally, the detergent compositions of the present disclosure may be used in known hand washing methods.

The present disclosure may also be directed to a method of treating a fabric, the method comprising the steps of contacting a fabric with a detergent composition described herein, carrying out a washing step, and then contacting the fabric with a fabric softening composition. The entire method, or at least the washing step, may be carried out by hand, be machine-assisted, or occur in an automatic washing machine. The step of contacting the fabric with a fabric softening composition may occur in the presence of water, for example during a rinse cycle of an automatic washing machine.

### Test Methods

### Malodor Reduction Test Method

The following method is used to test the malodor reduction benefits of a composition.

### A. Preparation of 75 Grams Malodor Marker

Fatty acids and malodor markers are added into 100 ml glass gar with Teflon-lined cap according to Table A and mixed well using a vortex.

TABLE A
Malodor marker composition

| | | % | Weight needed |
|---|---|---|---|
| Material | CAS # | Composition | (g) |
| Iso Valeric acid | 503-74-2 | 12.00 | 9.0 |
| Undecanal | 112-44-7 | 0.20 | 0.15 |
| Undecanoic | 112-37-8 | 62.80 | 47.1 |
| Acid | | | |
| Skatole | 83-34-1 | 1.00 | 0.75 |
| Decanoic Acid | 334-48-5 | 22.00 | 16.5 |
| Ethyl | 627-90-7 | 2.00 | 1.5 |
| undecanoate | | | |

### B. Preparation of Body Soil Malodor Composition

Provided the specified amount of each material according to Table B into a 200 mL glass jar with Teflon lined cap. Artificial body soil (ABS) is commercially available by Accurate Product Development; 2028 Bohlke Blvd, Fairfield, OH 45014.

TABLE B
Body soil malodor composition

| Material | Weight (g) |
|---|---|
| Malodor marker (from Table A) | 17.1 |
| Artificial Body Soil (ABS) | 15.8 |
| Di-propylene glycol monomethyl | 105 |
| ether (CAS: 34590-94-8) | |
| Squalene (CAS # 111-02-4) | 15.8 |

### C. Preparation of Malodor Test Fabrics

Ten malodor test fabrics per wash load are prepared by applying 250 μl of Body soil malodor composition described in Table B to de-sized 2.5×2 inch white polycotton 50/50

(PCW50/50) swatches. 2.31 grams of liquid detergent (Table C.) to be tested is added to 1 L tergotometer pots (tergotometer used to simulate the washing of fabrics in a washing machine) followed by the 10 malodor swatches and 30 cotton 6×6 inch ballast swatches. The pots were agitated at 25° C. and 7 US gpg at 208 rpm for 12 minutes and spun dry. Fabrics were then rinsed in 15° C. water at 7 US gpg at 167 rpm for 5 minutes and spun dry. After the rinse, the malodor swatches, separated from the ballast, were machine dried in a Maytag double stack tumble drier on high for 20 minutes. The dried fabrics are placed in a mylar bag and sealed for 0-72 hours before analysis.

### D. Analytical Detection of Malodor on Fabric

The malodor reduction using ABS/Squalene malodor sensors are quantitatively determined by Gas Chromatography Mass Spectroscopy using an Agilent gas chromatograph 7890B equipped with a mass selective detector (5977B), a Chemstation quantitation package and a Gerstel multi-purpose sampler equipped with a solid phase micro-extraction (SPME) probe. Calibration standards of 6-Methyl-5-hepten-2-one (CAS 110-93-0), Trans-2-heptenal (18829-55-5) and 3-methyl-2-Butenal (107-86-8) are prepared by dissolving a known weight of these materials in light mineral oil (CAS 8020-83-5) (each material available from Sigma Aldrich). Fabrics are cut into uniform 2 inch by 2.5 inch pieces and placed in 10 mL headspace crimp vials. Vials are equilibrated greater than 12 hours before analysis. The following settings are used in the auto sampler: 80 C incubation temperature, 90 min incubation time, VT32-10 sample tray type, 22 mm vial penetration, 20 min extraction time, 54 mm injection penetration and 300 s desorption time. The following settings are used for the Front Split/Splitless inlet helium: split mode, 250 C temperature, 12 psi pressure, 79.5 mL/min total flow, 3 mL/min septum purge flow, 50:1 split ratio and 22.5 min GC run time. The follow settings are used in the oven: 40 C initial temperature, 12 C/min heating program, 250 C temperature and 5 min hold time. Based on the partition coefficients (K at 80 C) of each component, the total nMol/L liter of 6-Methyl-5-hepten-2-one (K=3353), Trans-2-heptenal (K=3434), and 3-methyl-2-Butenal (K=1119) are calculated.

These values of these three measurements (in nmoles/L) are added together to provide the Total ABS/Squalene Markers (nmoles/L) for a given test leg.

### E. % Malodor Reduction Oxidation Products Calculations

The % Malodor Reduction Oxidation Products is provided as a percentage comparing the reduction of the amount of selected malodor markers as provided by the test composition compared to the (nil-antioxidant, nil-nonionic surfactant) reference composition. The value is determined as follows:

$$\% Reduction Oxidation Products = ( {Markers}_{ref} - {Markers}_{test} ) \times 100 / {Markers}_{ref}$$

Values for Markers_{ref} and Markersₜₑₛₜ are defined as follows:
Markers_{ref}=Total ABS/Squalene Markers (nmoles/L) of the fabrics washed with the formulation without antioxidant and/or nonionic surfactant (e.g., the reference or control formulation)
Markersₜₑₛₜ=Total ABS/Squalene Markers (nmoles/L) of the fabrics washed with the formulation with the tested antioxidant and/or nonionic surfactant

As the measured oxidation products are typically considered malodorous, it is believed that the greater the % reduction of oxidation products provided by a composition, the less malodorous the treated fabrics are likely to be. Therefore, greater values of % Malodor Reduction Oxidation Products are typically preferred. The compositions and processes of the present disclosure may provide a % Malodor Reduction Oxidation Products value of at least about 10%, or at least about 20%, or at least about 30%, or at least about 40%, or at least about 50%, or at least about 60%, or at least about 70%, or at least about 80%.

### EXAMPLES

The examples provided below are intended to be illustrative in nature and are not intended to be limiting. The following heavy duty liquid laundry detergent compositions may be prepared by traditional means known to those of ordinary skill in the art by mixing the listed ingredients Table 1.

TABLE 1

| Raw Material | Active Wt % |
|---|---|
| Nonionic surfactant (C12-14 EO9) (Surfonic L | X |
| 24-9; Indorama Ventures) | |
| Alkyl benzene sulfonate (dodecylbenzene | 5.6 |
| sulfonic acid; P&G) | |
| C12-14 Amine Oxide (amine oxides, C12-14- | 5.2 |
| alkyldimethyl; P&G) | |
| C12-18 Fatty Acid (TRC1218U_CLP; Twin | 3.2 |
| Rivers Technologies) | |
| Ethoxyquin (CAS 91-53-2; Millipore Sigma) | Y |
| Citric Acid (Citric acid 10-50%; Univar) | 3 |
| Propylene glycol (Propylene glycol; Dow | 3.6 |
| Chemical Corporation) | |
| Sodium Cumene Sulfonate (Naxonate 45SC; | 1.5 |
| Nease Co. LLC) | |
| Protease (Preferencz P283; Genencor | 0.7 |
| International, B.V.) | |
| Ethoxylated polyethyleneimine (ODD-base; | 3.5 |
| BASF) | |
| Amalyse (Fuji 200 L; Novozymes A/S) | 0.2 |
| Sodium hydroxide (Sodium hydroxide 5%-50%; | 2.2 |
| Premier Chemicals & Services, LLC) | |
| Mannanase (Mannaway 25 L; Novozymes A/S) | 0.04 |
| AF8017 Silicone Suds suppressor (Xiameter | 0.02 |
| AFE-0110 Antifoam emulsion; Dow Chemical | |
| Corporation) | |
| Water/Misc. | Balance |

Treatment compositions having the composition outlined in Table 1, along with the variable nonionic surfactant and ethoxyquin content shown below in Table 2 were created.

TABLE 2

| | | | | Oxidation marker |
|---|---|---|---|---|
| | | | Mean Oxidation | reduction (% |
| | X Wt % | | Marker | relative to |
| Compo- | (Nonionic | Y Wt % | Concentration | Comparative |
| sition | surfactant) | (Ethoxyquin) | (nmol/L) | Composition A) |
| A | 0 | 0 | 529.6 | 0.0 |
| B | 10.3 | 0 | 514.3 | 2.9 |
| C | 0 | 0.12 | 124.7 | 76.5 |
| 1 | 10.3 | 0.12 | 94.2 | 82.2 |
| D | 5.2 | 0 | 516.7 | 2.4 |
| E | 0 | 0.06 | 388.3 | 26.7 |
| 2 | 5.2 | 0.06 | 326.8 | 38.3 |
| F | 0 | 0.03 | 484.1 | 8.6 |
| G | 7.7 | 0 | 516.0 | 2.6 |
| 3 | 7.7 | 0.03 | 439.2 | 17.1 |

Compositions 1, 2, and 3 were prepared in accordance with the present disclosure by including both ethoxyquin and nonionic surfactant and exhibit synergistic oxidation marker reduction relative to Comparative Composition A. Comparative Compositions A, B, C, D, E, F, and G do not include both ethoxyquin and nonionic surfactant. Composition A is used as a baseline by not including any ethoxyquin or nonionic surfactant.

Composition 1 (which includes 10.3 wt % nonionic surfactant and 0.12 wt % ethoxyquin) synergistically outperforms Comparative Composition B (which only includes 10.3 wt % nonionic surfactant (no ethoxyquin)) and Comparative Composition C (which only includes 0.12 wt % ethoxyquin (no nonionic surfactant)). Specifically, the percentage of oxidation marker reduction relative to Composition A for Composition 1 would be expected to be the percentage of oxidation marker reduction relative to Composition A of Comparative Composition B (2.9%), and Comparative Composition C (76.5%) combined (B+C=79.4%). However, the percentage of oxidation marker reduction relative to Composition A for Composition 1 is 82.2%, greater than the combination of B+C (79.4%).

Composition 2 (which includes 5.2 wt % nonionic surfactant and 0.06 wt % ethoxyquin) synergistically outperforms Comparative Composition D (which only includes 5.2 wt % nonionic surfactant (no ethoxyquin)) and Comparative Composition E (which only includes 0.06 wt % ethoxyquin (no nonionic surfactant)). Specifically, the percentage of oxidation marker reduction relative to Composition A for Composition 2 would be expected to be the percentage of oxidation marker reduction relative to Composition A of Comparative Composition D (2.4%), and Comparative Composition E (26.7%) combined (D+E=29.1%). However, the percentage of oxidation marker reduction relative to Composition A for Composition 2 is 38.3%, greater than the combination of D+E (29.1%).

Composition 3 (which includes 7.7 wt % nonionic surfactant and 0.03 wt % ethoxyquin) synergistically outperforms Comparative Composition F (which only includes 0.03 wt % ethoxyquin (no nonionic surfactant)) and Comparative Composition G (which only includes 7.7 wt % nonionic surfactant (no ethoxyquin)). Specifically, the percentage of oxidation marker reduction relative to Composition A for Composition 3 would be expected to be the percentage of oxidation marker reduction relative to Composition A of Comparative Composition F (8.6%), and Comparative Composition G (2.6%) combined (F+G=11.2%). However, the percentage of oxidation marker reduction relative to Composition A for Composition 3 is 17.1%, greater than the combination of F+G (11.2%).

The compositions of the present disclosure may exhibit a mean oxidation marker concentration of less than 500 nanomoles per liter (nmol/L), less than 450 nmol/L, less than 400 nmol/L, less than 350 nmol/L, less than 300 nmol/L, less than 250 nmol/L, less than 200 nmol/L, less than 150 nmol/L, or less than 100 nmol/L. The compositions of the present disclosure may exhibit a mean oxidation marker concentration of from 1 to 500 nmol/L, from 1 to 450 nmol/L, from 1 to 400 nmol/L, from 1 to 350 nmol/L, from 1 to 300 nmol/L, from 1 to 250 nmol/L, from 1 to 200 nmol/L, from 1 to 150 nmol/L, from 1 to 100 nmol/L, from 25 to 500 nmol/L, from 25 to 450 nmol/L, from 25 to 400 nmol/L, from 25 to 350 nmol/L, from 25 to 300 nmol/L, from 25 to 250 nmol/L, from 25 to 200 nmol/L, from 25 to 150 nmol/L, from 25 to 100 nmol/L, from 50 to 500 nmol/L, from 50 to 450 nmol/L, from 50 to 400 nmol/L, from 50 to 350 nmol/L, from 50 to 300 nmol/L, from 50 to 250 nmol/L, from 50 to 200 nmol/L, from 50 to 150 nmol/L, from 50 to 100 nmol/L, from 75 to 500 nmol/L, from 75 to 450 nmol/L, from 75 to 400 nmol/L, from 75 to 350 nmol/L, from 75 to 300 nmol/L, from 75 to 250 nmol/L, from 75 to 200 nmol/L, from 75 to 150 nmol/L, from 75 to 100 nmol/L, or any values within the foregoing ranges or any ranges created thereby.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any disclosure or claims herein or that it alone, or in any combination with any other reference or references, teaches, suggests or discloses any examples of the present disclosure. Further, to the extent that any meaning or definition of a term in this document conflicts with any meaning or definition of the same term in a document incorporated by reference, the meaning or definition assigned to that term in this document shall govern.

While particular examples of the present disclosure have been illustrated and described, it would be obvious to those skilled in the art that various other changes and modifications can be made without departing from the spirit and scope of the disclosure. It is therefore intended to cover in the appended claims all such changes and modifications that are within the scope of this disclosure.

What is claimed is:

1. A treatment composition comprising:
from about 0.001 to about 3 wt %, by weight of the treatment composition, of ethoxyquin;
ethoxyquin dimer; and
from about 1 wt % to about 20 wt %, by weight of the treatment composition, of nonionic surfactant.

2. The treatment composition of claim 1, wherein the treatment composition comprises from about 0.01 to about 1 wt %, by weight of the treatment composition, of the ethoxyquin.

3. The treatment composition of claim 1, wherein the treatment composition comprises from about 0.01 to about 0.5 wt %, by weight of the treatment composition, of the ethoxyquin.

4. The treatment composition of claim 1, wherein the treatment composition comprises from 1 to 10 ppm of the ethoxyquin dimer.

5. The treatment composition of claim 1, wherein the treatment composition comprises from about 3 wt % to about 15 wt %, by weight of the treatment composition, of the nonionic surfactant.

6. The treatment composition of claim 1, wherein the nonionic surfactant comprises an alcohol alkoxylate, an oxo-synthesized alcohol alkoxylate, a Guerbet alcohol alkoxylate, an alkyl phenol alcohol alkoxylate, an alkylpolyglucoside, or combinations thereof.

7. The treatment composition of claim 1, further comprising an additional treatment adjunct selected from a surfactant system, fabric conditioning active (FCA), antioxidant, hueing agent, optical brightener, additional chelating agents, enzymes, fatty acids and/or salts thereof, encapsulated benefit agents, soil release polymers, builders, dye transfer inhibiting agents, dispersants, enzyme stabilizers, catalytic materials, bleaching agents, bleach catalysts, bleach activators, polymeric dispersing agents, soil removal/anti-redeposition agents, polymeric grease cleaning agents, amphiphilic copolymers, suds suppressors, aesthetic dyes, perfume, structure elasticizing agents, fabric softeners, carriers, fillers, hydrotropes, solvents, anti-microbial agents and/or preservatives, pH adjusting agents, processing aids, fillers, rheology modifiers, structurants, opacifiers, pearlescent agents, pigments, anti-corrosion agents, anti-tarnishing agents, antifoams, chlorine scavengers, and mixtures thereof.

8. The treatment composition of claim 7, wherein the additional treatment adjunct comprises a surfactant system, wherein the surfactant system comprises anionic surfactant.

9. The treatment composition of claim 8, wherein the anionic surfactant comprises at least one of amine oxide, alkyl ethoxylated sulfate, sodium lauryl sulfate, linear alkyl benzene sulfonic acid, branched 2-alkyl primary alkyl alcohol sulfate, alkyl sulphate, or a combination thereof.

10. The treatment composition of claim 7, wherein the additional treatment adjunct comprises a whitening or brightening agent selected from the group consisting of a hueing agent, an optical brightener, and mixtures thereof.

11. The treatment composition of claim 7, wherein the additional treatment adjunct comprises about 0.1 to about 10 wt %, by weight of the treatment composition, of a chelating agent by weight of the treatment composition.

12. The treatment composition of claim 7, wherein the additional treatment adjunct comprises an enzyme selected from the group consisting of protease, amylase, lipase, cellulase, phosphodiesterase, pectate lyase, and mixtures thereof.

13. The treatment composition of claim 1, wherein the treatment composition is a laundry detergent composition.

14. The treatment composition of claim 1, wherein the treatment composition is in a form selected from a liquid composition, a granular composition, a single-compartment pouch, a multi-compartment pouch, a dissolvable sheet, a pastille or bead, a fibrous article, a tablet, a bar, a flake, a dryer sheet, and mixtures thereof.

15. A single unit dose detergent comprising the treatment composition of claim 1.

16. The single unit dose detergent of claim 15, wherein the single unit dose is in the form is a water soluble fibrous article.

17. A method for treating a stain on a fabric, comprising:
washing the fabric in a wash liquor comprising a treatment composition comprising:
from about 0.01 to about 3 wt %, by weight of the treatment composition, of ethoxyquin;
ethoxyquin dimer; and
from about 1 wt % to about 20 wt %, by weight of the treatment composition, of nonionic surfactant.

18. The method of claim 17, comprising from about 0.01 to about 1 wt %, by weight of the treatment composition, of ethoxyquin.

19. The method of claim 17, wherein the nonionic surfactant comprises an alcohol alkoxylate, an oxo-synthesized alcohol alkoxylate, a Guerbet alcohol alkoxylate, an alkyl phenol alcohol alkoxylate, an alkylpolyglucoside, or combinations thereof.

20. The method of claim 17, wherein after washing the fabric in the wash liquor, there is an oxidation marker concentration of less than 400 nmol/L.
